(19) United States
(12) Patent Application Publication
(10) Pub. No.: US 2016/0121536 A1
(43) Pub. Date: May 5, 2016

(54) Dynamically Engineered Radius Extruding Device and Methods of Using the Same

(71) Applicant: Triumph Aerostructures, LLC, Berwyn, PA (US)

(72) Inventors: Ian Conrad Derx, Richardson, TX (US); John Ellis, Carrollton, TX (US)

(21) Appl. No.: 14/930,716

(22) Filed: Nov. 3, 2015

Related U.S. Application Data
(60) Provisional application No. 62/074,918, filed on Nov. 4, 2014.

(51) Int. Cl. B29C 47/12; B29C 47/00

(52) U.S. Cl. CPC B29C 47/124; B29C 47/0009; B29C 47/122; B29K 2105/253

(57) ABSTRACT

Devices and methods for shaping and extruding void filling materials are provided.

### CROSS-REFERENCE TO RELATED APPLICATIONS

The present application claims the benefit of U.S. Provisional Application No. 62/074,918, filed Nov. 4, 2014, the entirety of which is incorporated herein by reference.

### FIELD OF THE INVENTION

The present invention relates generally to devices and methods for forming materials and more particularly, but not exclusively, to devices and methods for extruding formable materials with a triangular cross-section.

### BACKGROUND OF THE INVENTION

During laminate fabrication, the joining of structural components may result in a void space that may be filled by the insertion of a composite. For example, in the laminate fabrication of aircraft, the wings of such aircraft may include spars that support the interior of the wing. Where these spars connect to the interior surfaces of the wing structure, void spaces may result that detract from the preferred monolithic structure of the wing. Therefore, fillers (i.e., roving, noodles, and/or composite deltoid) are often driven into these void spaces prior to joining the spars to the aircraft structure in order to fill the voids and provide a monolithic structure to the wing.

However, the fillers used in filling these void spaces must often be formed into the shape of the void space prior to their application. The devices and methods known in the field do not adequately shape these fillers to conform to the shape of the void space and, as a result, portions of the void space may remain. These unfilled void spaces can reduce the overall structural integrity of the wing structure.

Accordingly, a need exists in the field for devices and methods that can shape fillers to conform to the void spaces created during the fabrication of aircraft components. The present invention meets this need.

### SUMMARY OF THE INVENTION

The present invention meets the needs in the field by providing extruders and methods of using such extruders for forming, shaping, extruding, or otherwise working formable materials such as preform materials, roving, noodles, composite deltoid, and the like. Accordingly, the devices and methods described herein provide extruded fillers and/or composites that conform to or match void spaces. These may include the void spaces created during laminate fabrication, such as the fabrication of aircraft components.

In one aspect, the present invention includes an extruder for forming materials. The extruder may include a first angled roller having a first forming surface and a second angled roller having a second forming surface that is proximate to the first angled roller. The extruder may also include a passive roller having a counter surface (which may also be an additional forming surface) that may be proximate to the first angled roller and the second angled roller. Moreover, the first forming surface, second forming surface, and counter surface may be arranged to extrude a formable material with a triangular cross-section. Furthermore, the extruder of the invention may include a drive assembly that may be operably connected to one or more of the first angled roller, second angled roller, and passive roller.

In another aspect, the present invention includes a variable-radius extruder for forming or extruding formable materials. The variable-radius extruder may have a first roller having a first curved forming surface that includes two or more radii and a second roller having a second curved surface that includes two or more radii where the second roller may be proximate to the first roller. The variable-radius extruder may also include a passive roller having a counter surface that may be proximate to the first roller and the second roller, with the first curved surface, second curved surface, and counter surface arranged to extrude a formable material or noodle with a triangular cross-section. Furthermore, the first and second rollers may be positioned with respect to the counter surface at a forming angle, wherein adjusting the forming angle varies the triangular cross-section.

In a still further aspect, the present invention includes a method of shaping a formable material with an extruder. The extruder of the method may have a first roller, a second roller, and a passive roller. The method may include aligning the first roller, second roller, and passive roller to provide a rolling die having a triangular cross-section. Moreover, the first and second rollers may be provided with first and second forming surfaces. The method may further include providing a formable material to the rolling die and then forming the formable material by drawing the formable material through the rolling die. Additionally, forming the formable material may include applying a first forming force to the formable material with the first roller, a second forming force to the formable material with the second roller, and a third forming force to the formable material with the passive roller.

### BRIEF DESCRIPTION OF THE DRAWINGS

The foregoing summary and the following detailed description of the exemplary embodiments of the present invention may be further understood when read in conjunction with the appended drawings, in which:

FIGS. 1A and 1B schematically illustrate axial (FIG. 1A) and radial (FIG. 1B) views of an exemplary angled roller of the invention;

FIG. 2 schematically illustrates material forming rollers of the invention including the positioning of the angled rollers and passive roller;

FIG. 3 schematically illustrates a perspective view of an exemplary material extrusion device of the invention;

FIGS. 4A and 4B schematically illustrate side-on views of the exemplary material extrusion device of the invention;

FIG. 5 schematically illustrates a front view of the exemplary material extrusion device of the invention;

FIG. 6 schematically illustrates a side-on view of the exemplary material extrusion device of the invention in an open configuration demonstrating how the angled rollers or passive roller may be removed by a user;

FIGS. 7A and 7B schematically illustrate a radial view of a variable-radius roller of the invention (FIG. 7A) and an expanded view of the forming surface of the variable-radius roller (FIG. 7B);

FIGS. 8A and 8B schematically illustrate a perspective view of an exemplary variable-radius extruder device (FIG. 8A) and a front view of an exemplary variable-radius extruder device (FIG. 8B) that includes a driven passive roller;

FIG. 9 schematically illustrates a perspective view of an exemplary extruding device 700 that includes a housing and a powered drive assembly (i.e., an electric motor);

FIGS. 10A and 10B schematically illustrate side (FIG. 10A) and front (FIG. 10B) views of the exemplary extruding device 700;

FIG. 11 schematically illustrates a cross-sectional view of the exemplary extruding device 700;

FIG. 12 pictorially demonstrates the cross-section of a tightly rolled noodle (area A) that has been vacuum formed into a triangle by methods known in the art where the noodle preform was triangular and used to fill a 0.47 inch void (area B). There are ply thickness variances that indicate density differences along the axis of the noodle (area C). A resin pool exists due to the presence of a low pressure area from the radius created along the edge of the dense noodle (area D); and

FIG. 13 pictorially demonstrates the cross-section of a loosely rolled noodle (area A) that has been machine formed by an exemplary device of the invention where the noodle preform had a 0.29 inch radius (area B). Pooling of resin has been eliminated with the deeper penetration of the formed noodle (area C). Ply thickness is maintained and fiber distortion is eliminated in contrast to the prior art forming methods (area D).

### DETAILED DESCRIPTION OF THE INVENTION

When fabricating composite structures or components, such as aircraft components, the laminate fabrication processes of such components may result in void spaces that can detract from the desired monolithic structure of the components. In order to remove the void spaces, composite fillers may be placed in the void. However, if the shape of the filler does not match the shape of the void space, then portions of the void spaces may remain unfilled. In an effort to remove these unfilled portions, technicians may attempt to drive poorly fitting filler into the void spaces with hand tools, which may result in the non-uniform and inconsistent application of filler and worker fatigue. Furthermore, present production requires preform fillers to be dense, which creates high pressure areas along the tooling radius apex. This can lead to low pressure zones at the tips of the void where resin may pool. As a result, there is a need in the field for extruding devices and methods that can shape or form filler materials so as to match the shape of the void spaces and remove the necessity of additional steps or processes that are currently required in the field.

The present devices of the invention provide three rollers that may apply pressure normal to a preformed filler. As such, the resulting formed filler material that is extruded through the devices of the invention has a triangular cross-section. As used herein, a “triangular cross-section,” may include a normal triangular cross-section (i.e., equilateral or scalene triangular cross-section), a convex triangular cross-section, a concave triangular cross-section, and the like. In certain embodiments, the triangular cross-section of the invention is a concave triangular cross-section. The resulting formed fillers extruded by the devices of the invention more closely match the void spaces that result from, for example, laminate fabrication processes.

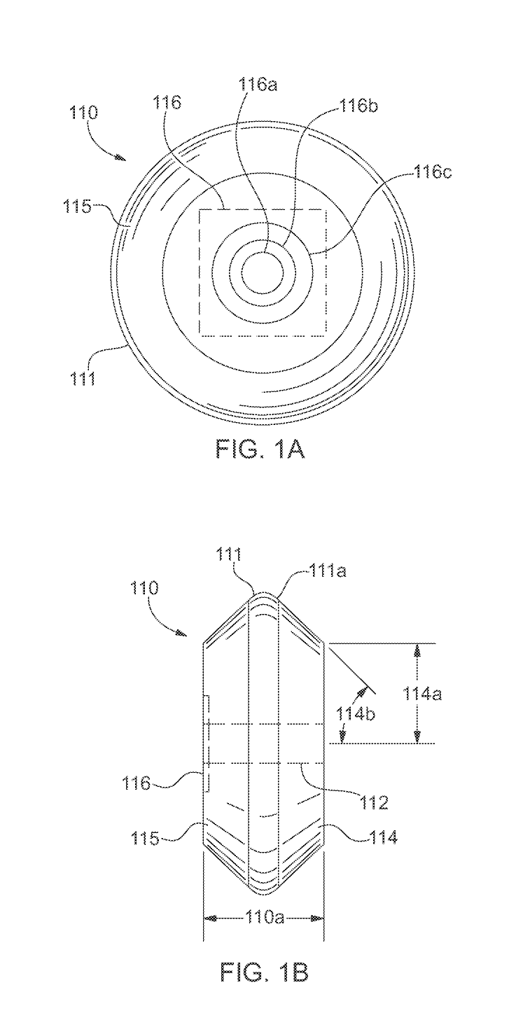

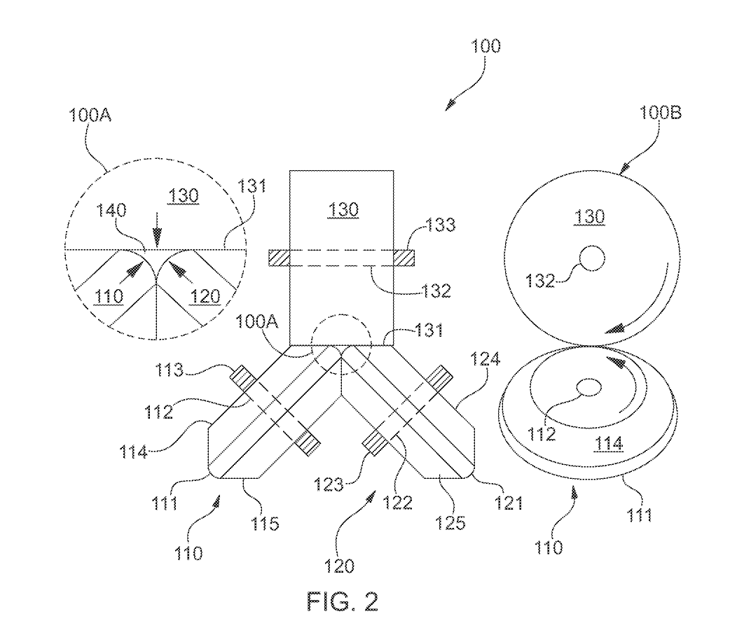

Referring now to the figures, wherein like elements are numbered alike throughout, FIGS. 1A, 1B, and 2 demonstrate exemplary angled rollers 110 and 120 as they may be deployed in a material forming device 100.

The angled roller 110 includes a forming surface 111. The forming surface may be curved and may include a forming surface radius 111a. The forming surface radius 111a may be about 0.01 to 100 inches. In certain aspects, the forming surface radius 111a may be about 0.1 to 10 inches. In an exemplary embodiment, the forming surface radius 111a is about 0.25 inches. The forming surface 111 may be provided or varied based on the ply boundary radius or area fill to match the curvature of the forming surface 111 and forming surface radius 111a to the shape of the void space in order to extrude the appropriately shaped filler material.

The angled roller 110 may further include a shaft 112 that may be sized to include an axle 113 (see FIG. 2). Passing through the shaft 112 is an axis of rotation that is normal to the radial plane of the angled roller 110. The angled roller 110 may include an outer face 114 and an inner face 115. Both the outer face 114 and inner face 115 may be bevelled having an outer radius that extends to the forming surface 111 and an inner radius that extends to the bevelled surface of the faces 114 and 115. For example, the inner radius 114a may be about 0.01 to 100 inches. In an exemplary embodiment, the inner radius 114a is about 1.25 inches. Moreover, the outer face 114 and inner face 115 may have a bevel angle 114b of about 15° to 75° between the bevelled surface of the inner or outer faces and the axis of rotation passing through the shaft 112. In an exemplary embodiment, the outer face 114 and inner face 115 are bevelled at an angle of about 45°. Still further, the outer face 114 and inner face 115 may be bevelled at any angle provided the bevelled surfaces of the angled rollers contact at their respective tangents as shown in FIG. 2. The angled roller 110 may further include a roller width 110a measured between the outer face 114 and inner face 115. The roller width 110a may be about 0.01 to 100 inches or, in certain aspects, about 0.1 to 50 inches. In an exemplary embodiment, the roller width 110a is about 1.5 inches.

Although the angled roller 110 of the invention may be designed to be mounted on either the outer face 114 or inner face 115, in preferred aspects of the invention, a roller mount 116 is provided on the inner surface 115. The roller mount may include a bracket and one or more grooves that include bearings to allow the angled roller 110 to both remain fixed and simultaneously rotate smoothly. In one embodiment of the invention, the roller mount 116 may include concentric rings 116a, 116b, and 116c that may include bearing systems and may match a fixation point on a driver assembly, as will be discussed herein, or other mounting surface. In an exemplary embodiment of the invention, 116a may be the shaft radius, 116b may be the outer diameter of an associated bearing race, and 116c may be a clearance for the outer diameter bearing race. Specifically, the radii of rings 116a, 116b, and 116c, may be described as 116a<116b<116c. For example, the rings 116a, 116b, and 116c may have radii of about 0.01 to 50 inches.

Referring to FIG. 2, the material forming device 100 may include a first angled roller 110, a second angled roller 120, and a passive roller 130. One or more of the first angled roller 110, second angled roller 120, and passive roller 130 may be composed of metal, plastic, or a combination thereof In certain aspects, the first angled roller 110, second angled roller 120, and passive roller 130 may be composed of a metal such as steel or aluminum, for example.

Addressing the angled rollers 110 and 120, such rollers may be positioned beneath or above the passive roller 130. As set forth above, the first and second angled rollers 110, 120 may include forming surfaces 111,121, shafts 112,122, outer faces 114,124, and inner faces 115,125. Passing through the first and second shafts 112 and 122, respectively, may be first and second axles 113 and 123. As demonstrated in FIG. 2, the first and second angled rollers 110 and 120 may be positioned such that they mirror each other. For example, the first and second inner faces 115 and 125, respectively, may be bevelled to allow the first and second angled rollers to roll against each other while also allowing the first and second forming surfaces 111 and 121 to be placed proximate each other. Moreover, the first and second rollers 110 and 120 may be aligned at a forming angle measured between the radial axes of the first and second rollers 110 and 120.

Turning to the passive roller 130, the passive roller may have a shaft 132 and an axle 133. Moreover, the passive roller 130 may include a counter surface 131. The passive roller 130 may be positioned such that the counter surface 131 contacts the first angled roller 110 and/or the second angled roller 120. Where the counter surface 131 contacts the first angled roller 110 and/or second angled roller 120, the first and second outer faces 115,125 may be bevelled to allow the first and second angled rollers to roll against the counter surface 131 as shown at insets 100A and 100B.

Regarding inset 100A, the first angled roller 110, second angled roller 120, and passive roller 130, combine to form a rolling die 140 that may extrude a formable material with a triangular cross-section. Moreover, the broad arrows shown in inset 100A illustrate the application of three forces that are applied by respective rollers 110, 120, and 130 normal to a filler preform that may be provided to the rolling die 140.

The shape of the rolling die 140 may be modified or adjusted by modifying the curvature or shape of the first and second forming surfaces 111 and 121 as set forth above. Additionally, the shape of the rolling die 140 may be modified or adjusted by modifying the shape of the counter surface 131. For example, the counter surface 131 may be flat, convex, or concave. In certain aspects, the counter surface 131 is flat.

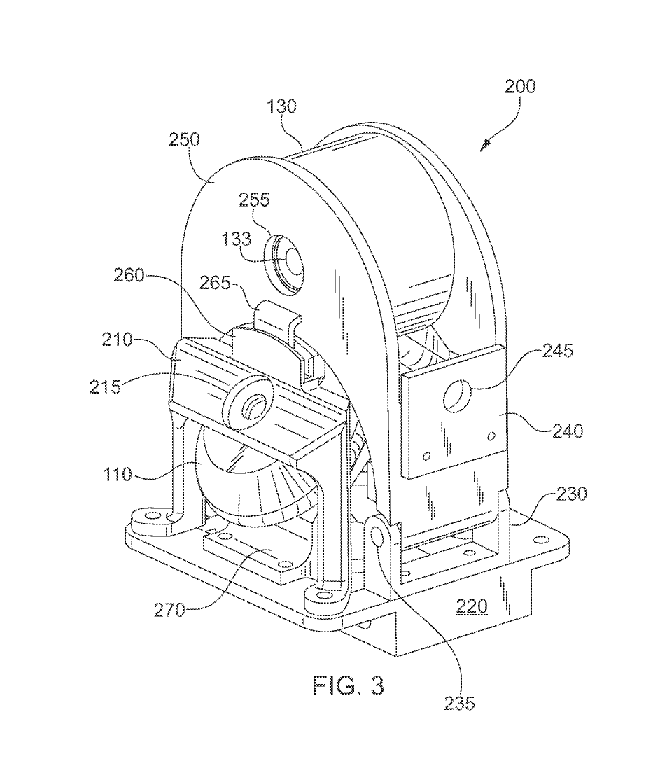

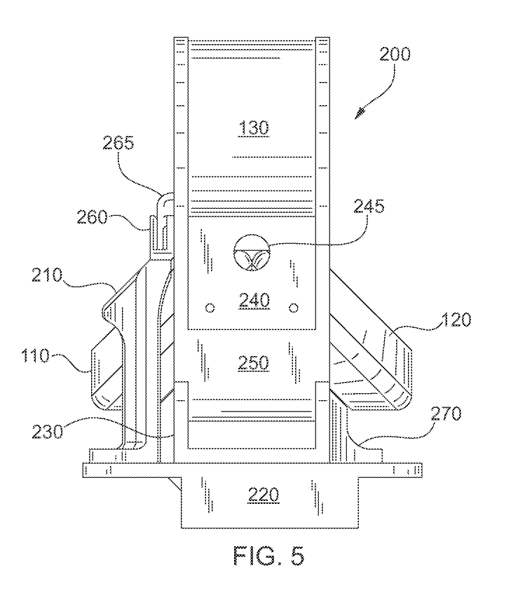

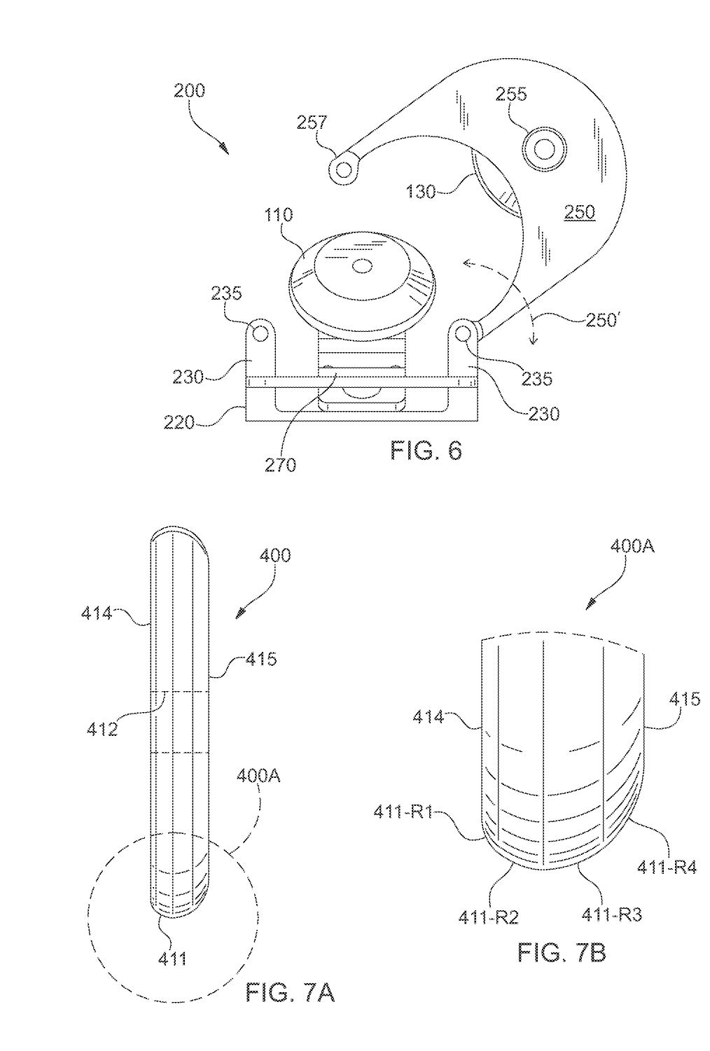

Referring to FIGS. 3 to 5, the material forming device 100 may be provided in an exemplary extruder 200. In FIG. 3, the extruder 200 may include a drive base 220 that may house a powered or manual drive assembly for driving one or more of rollers 110, 120, and 130. The extruder 200 may include a housing 250 that is rotatably mounted to the drive base 220 through one or more housing brackets 230. The housing bracket 230 may further include a rotatable fixation element 235, such as a bolt or rod, that attaches to the housing 250 via a housing hub 257 (see FIG. 6) that may be placed on or about the housing 250. As used herein, the one or more motors of the invention may operate to allow the extruders of the invention to process preform material at a rate of between about 0.1 and 100 inches per second. In certain aspects, the extruders of the invention may process preform material at a rate of between about 0.5 and 20 inches per second. For example, the extruders of the invention may process preform material at a rate of about 3 inches per second. Accordingly, in certain aspects, the extruders of the invention may operate at a speed or rate of about 15 feet per minute.

The housing 250 may further include the passive roller 130 that may be mounted at the housing by securing the axle 133 at axle mount 255. The axle mount 255 may have one or more bearing assemblies allowing the passive roller 130 to freely rotate about its axis of rotation. In alternative embodiments, the manual drive assembly (e.g., a hand crank) or a powered drive assembly (e.g., one or more electric motors) may be operably connected to the axle 133 at the axle mount 255 to drive the passive roller 130. However, in certain preferred embodiments, the passive roller 130 may be allowed to rotate freely.

Moreover, the housing 250 may include a face plate 240 that may be removably secured to the front of the housing 250. The face plate 240 may also include a first aperture or guide 245 through which a filler preform may pass and thereby enter the extruder 200 in alignment with the rolling die 140. Although not set forth in FIGS. 3-6 a second aperture or production port may be provided at the rear of the housing 250 in line with first aperture 245. Therefore, during operation of the exemplary extruder 200, a preform filler may pass through the first aperture 245, enter the rolling die 140 and, after being formed, may exit the extruder 200 at the second aperture disposed at the back of the housing 250.

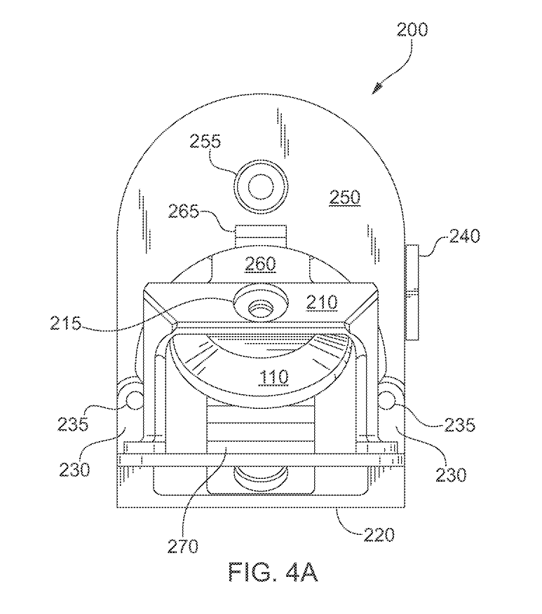

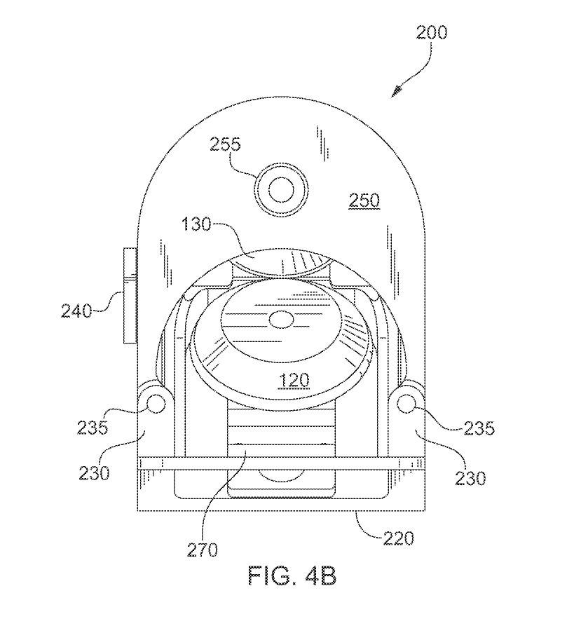

The extruder 200 may include a housing lock assembly 210 that may be connected to the drive base 220 by one or more fixation elements, such as bolts or screws. The housing lock assembly 210 may extend over the first angled roller 110 or second angled roller 120. In one embodiment, as shown in FIGS. 3 and 4A, the housing lock assembly 210 may extend over the first angled roller 110. The housing lock assembly 210 may include an axle mount 215. The axle 113 of the first angled roller 110 may be rotatably mounted to the axle mount 215. However, in certain other embodiments, the axle 113 need not be mounted to the axle mount 215 and such mount may act as a pass through for the axle 113. The housing lock assembly may also include a housing lock 260. The housing lock 260 may include a receiver slot that may receive a housing tongue 265 that extends from a portion of the housing 250 proximate to the housing lock 260. The housing tongue 265 may include one or more ridges that may be captured by housing lock 260 by devices and methods known to the person having ordinary skill in the art (e.g., one or more biased protrusions such as, for example, a clip or clasp). Accordingly, the housing lock 260 and the housing tongue 265 operate together to maintain the position of the housing 250 and keep the extruder 200 in a closed position during operation.

The extruder 200 may also include a roller drive assembly 270. The roller drive assembly 270 may be mounted on the drive base 220 and may include angled roller mounting elements for rotatably mounting the first and second angled rollers 110,120. For example, the first and second angled rollers 110,120 may be rotatably mounted at their inner faces 115,125 through a first and second roller mounts, such as exemplary roller mount 116 (see FIG. 1). The angled roller mounts upon the roller drive assembly 270 may include one or more bearing systems to allow the first and second angled rollers 110,120 to roll freely. Moreover, the roller drive assembly 270 may be operably connected through one or more gears, rods, and the like, to the one or more motors disposed in the drive mount 220.

In the exemplary extruder 200, first and second angled rollers 110,120 may be rotatably mounted to the roller drive assembly 270 via their axles 113,123 to angled roller mounts provided on the roller drive assembly 270. The axles 113,123 are then in rotational communication (e.g., mechanically connected) with the one or more gears or rods of the roller drive assembly 270, to transmit driving power from the one or more motors of the driver mount 220 to first and second angled rollers 110,120. Furthermore, such one or more gears or rods of the roller drive assembly 270 are configured such that where one of the angled rollers 110 or 120 is rotating in a counter-clockwise fashion, the other angled roller is rotating in a clockwise fashion, and vice versa. The arrangement of such gears or rods may be provided as known by a person having ordinary skill in the art who may be familiar with systems that transmit driving power from a motor to a wheel or roller through gears, rods, axles, and the like. The various arrangements of gears or rods that may be used to transmit power from the one or more motors of the driver mount 220 to the first and second angled rollers 110,120 are within the scope of this invention.

In alternative embodiments, one or more roller locks may be placed about the outer faces 114,124 of the first and second angled rollers 110, 120, which may include the one or more roller locks being attached to or about the axles 113,123 to removably fix the first and second angled rollers 110,120 to the roller drive assembly 270. For example, in certain embodiments where the axles 113,123 are fixed to the angled roller mounts provided on the roller drive assembly 270, the first and second angled rollers 110,120 may be placed over the axles 113,123, with such axles passing through shafts 112 and 122, respectively. After passing the axles 113,123 through the shafts 112,122, the first and second angled rollers 110,120 may be removably fixed in place by turning one or more butterfly nuts, for example, onto the ends of the axles 113,123, thereby removably fixing the first and second angled rollers 110,120 in place during operation. In addition to a butterfly nut, any other nut or fixation element may be used that may be placed at the axles 113,123 to prevent slippage or removal of the first and second angled rollers 110 and 120.

Referring now to FIG. 6, the first and second angled rollers 110 and 120 may be removed from the open extruder 300. Specifically, one of the fixation elements 235, that are positioned at the front or back of the extruder 300, may be removed allowing the housing 250 to pivot open on the housing bracket 230.

The present invention also includes methods of forming or shaping a formable material with an extruder such as exemplary extruder 200. As indicated above, an extruder of the invention may include a first angled roller 110, a second angled roller 120, and a passive roller 130. The three rollers 110, 120, and 130 combine to both draw the formable material through the extruder as well as shape the formable material by applying pressure to the formable material in three directions that are normal to the surfaces of the formable material. The method may include obtaining a sheet or length of preform formable material. When the formable material is presented in the form of sheet, such material may be rolled into a tube shape to provide a prepared preform material. In certain aspects of the invention, the preform material may be rolled tightly or loosely. The preform material is preferably rolled loosely. The formable material may then be prepared for forming in the extruder 200.

The method of the invention may include preparing the extruder 200 by selecting first and second rollers 110 and 120 having forming surfaces 111 and 121 that, when placed in the extruder 200, provide a rolling die 140 having a selected triangular cross-section. The selected triangular cross-section may be, for example, a convex or concave triangular cross-section that substantially matches the shape of a void space, such as an aircraft component's void space (e.g., a void space present in an aircraft flap or spar). After the first and second rollers 110 and 120 are selected and placed in the extruder 200, the device may be activated and the formable material may be provided to the extruder 200 at the rolling die 140 through the aperture or guide 245. The guide 245 may be a circular opening that may have a radius (R_{A}) that is greater than 100% R_{P}, where R_{P} is the radius of the preform formable material. The R_{A} may be a value that is greater than 100% R_{P} and less than or equal to 200% R_{P}. For example, R_{A} may be about 125% R_{P}. Moreover, the guide 245 may comprise a mechanical iris that allows for the radius of the guide 245 to be varied from closed to a radius R_{A}, as necessary, to provide a selected radius as needed by the user of the extruder 200 to guide the formable material to and through the rolling die 140 depending on the size of the formable material. Regarding the sizes of certain preform materials formed or extruded by the devices of the invention, such preform materials may be substantially cylindrical and may have an R_{P} of about 0.01 to 10 inches. In other aspects, R_{P} may be about 0.1 to 1.0 inches. In certain embodiments, R_{P} may be about 0.1 to 0.5 inches.

After providing the formable material to the rolling die 140, the formable material may be drawn through the rolling die 140, thereby extruding the formable material with a triangular cross-section that matches the cross-section of the rolling die 140. The resulting formed material may then be removed from the extruder 200 via a second aperture or production port that may be provided at the rear of the housing 250, in line with first aperture 245.

Additionally, the methods of the invention may also include heating the formable material with a heating source prior to forming, where the heating source may be positioned proximate to the aperture or guide 245. In certain embodiments, the heating source may be mounted on the housing 250 to heat the formable material either before or after the formable material enters the guide 245. Indeed, the heating source may be placed either on an exterior surface of the housing 250 or an interior surface of the housing 250. The heating source may be an infrared (IR) heating source, for example. However, any heating source that provides heat that is compatible with the formable material to soften the formable material is encompassed within the scope of this invention.

As shown above, the first and second angled rollers 110 and 120 of extruder 200 have fixed radii at their respective forming surfaces 111 and 121. Therefore, if different formed materials are required, having different triangular cross-sections, a user may need to open the extruder 200, as shown by the open configuration 300 in FIG. 6, then remove the first and second angled rollers 110 and 120. After removing the first set of angled rollers, a second set of angled rollers may need to be introduced or fitted into the extruder 200 that have different that have different forming surfaces compared to the forming surfaces of the first set of angled rollers. The second set of angled rollers could then provide a triangular cross-section at the rolling die 140 that differs from the triangular cross-section provided by the first set of angled rollers.

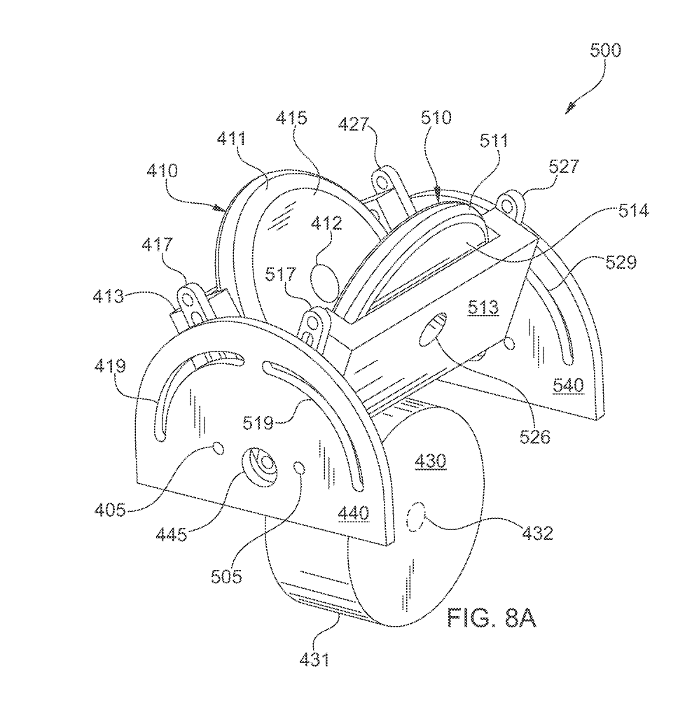

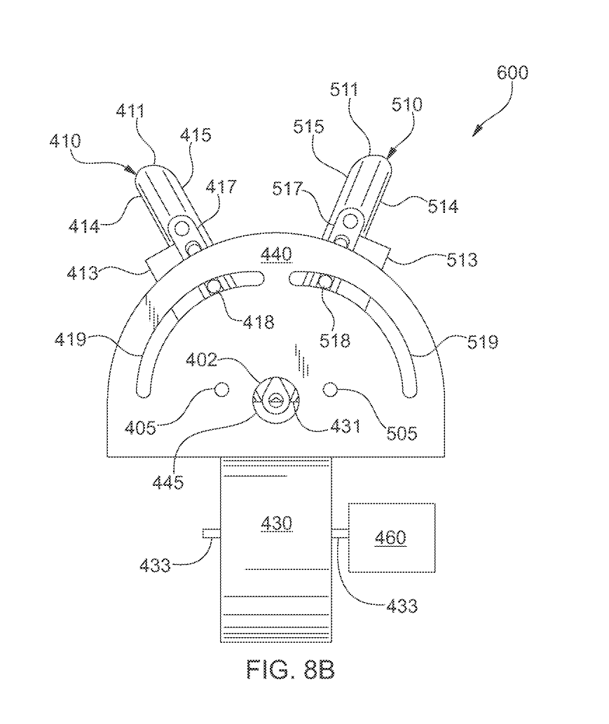

Referring to FIGS. 7 and 8, the present invention also includes a variable-radius roller extruder 500 and 600 for forming or shaping formable materials. In contrast to the exemplary extruder 200, the variable-radius extruder 500 and 600 includes two variable-radius rollers 400 that have curved forming surfaces that include more than one radii. Therefore, by changing the forming angle at which the variable-radius rollers contact the passive roller the resulting triangular cross-section at the rolling die may be changed accordingly without necessitating the removal or replacement of the variable-radius rollers themselves.

As shown in FIGS. 7A and 7B, an exemplary variable-radius roller 400 is provided that includes an outer face 414, an inner face 415, a shaft 412 through which an axle may pass, and a variable-radius forming surface 411, which is shown in detail at inset 400A in FIG. 7B. The variable-radius forming surface may include a curved surface having two or more arcs 411-Rn. Each individual arc 411-Rn may have a unique radius R where n is number of the number of the arc. The radius for each arc may be about 0.01 to 100 inches. In other aspects, the radius for each arc may be about 0.1 to about 10 inches. For example, the variable-radius forming surface 411 in FIG. 7B includes four arcs listed as 411-R1, 411-R2, 411-R3, and 411-R4. Each arc represents an individual forming surface and, as the forming angle is adjusted, a different individual forming surface 411-Rn may interact at the resulting variable-radius rolling die that it is provided when two variable-radius rollers and a passive roller interact. In certain aspects, where two of the arcs 411-Rn meet at the variable-radius forming surface 411, they may or may not share a common tangent. In certain aspects of the invention, the variable-radius forming surface 411 may include 2 to 10 unique arcs. However, in certain embodiments, the variable-radius forming surface 411 includes 2 to 6 arcs. For example, the variable-radius forming surface 411 includes 4 arcs as shown in FIG. 7B. Moreover, in other aspects of the invention, the arc radius may increase for each individual arc 411-Rn upon viewing the arcs from the outer face 414 to the inner face 415. Variable-radius rollers of the invention, such as variable-radius roller 400, may utilize multiple tangent radii over the 180 degree arc of the roller. This allows for variability in the preform material based on the angle of the roller. Indeed, in additional aspects of the variable-radius rollers of the invention, the forming surface 411 may have a gradually changing radius along the curved surface between a first radius and a second radius such that no two points on the curved surface between the first and second radius share the same radius.

Referring to FIGS. 8A and 8B, the present invention includes variable-radius extruders 500 and 600. Exemplary variable-radius extruders 500 and 600 are differentiated in that variable-radius extruder 600 includes drive assembly 460, which is connected to axle 433 of the passive roller 430.

Regarding variable-radius extruders 500 and 600, they include a first variable-radius roller 410, a second variable-radius roller 510, and a passive roller 430. One or more of the first and second variable-radius roller 410,510 and passive roller 430 may be composed of metal, plastic, or a combination thereof In certain aspects, the first variable-radius roller 410, second variable-radius roller 510, and passive roller 430 may be composed of a metal such as steel or aluminum for example. Moreover, as shown specifically in FIG. 8B, the variable-radius forming surfaces 411,511 and a counter surface 431 disposed on the passive roller 430 combine to form variable rolling die 431 having a triangular cross-section. The triangular cross-section of the variable rolling die 431 may be convex or concave, but is preferably concave. Additionally, the shape of the variable rolling die 431 may be modified or adjusted by modifying the shape of the counter surface 431. For example, the counter surface 431 may be flat, convex, or concave. In certain aspects, the counter surface 431 is flat.

Addressing the variable-radius rollers 410 and 510, such rollers may be positioned beneath or above the passive roller 430. As set forth above, the first and second variable-radius rollers 410 and 510 may include variable-radius forming surfaces 411 and 511, shafts 412,512 (where shaft 512 is not shown), outer faces 414,514, and inner faces 415,515. Passing through the first and second shafts 412 and 512, respectively, may be first and second axles. The first and second axles may further rotatably engage with first and second variable-angle mounts 413 and 513, respectively, through first and second roller mounting assemblies, such as roller mounting assembly 526. Roller mounting assemblies may have one or more bearing assemblies allowing the first and second variable-angle mounts 413 and 513 to rotate freely about their axes of rotation.

In alternative embodiments, one or more roller locks may be placed about the inner faces 415,515 of the first and second variable-radius rollers 410,510, which may include the one or more roller locks being attached to or about the axles that may extend through the shafts of the first and second variable-radius rollers, such as shaft 412, to removably fix the first and second variable-radius rollers 410,510 to the first and second variable-angle mounts 413,513. For example, in certain embodiments where the axles are fixed to the variable angle roller mounts, the first and second variable-radius rollers 410,510 may be placed over the axles. After passing the axles, the first and second variable-radius rollers 410,510 may be removably fixed in place by turning one or more butterfly nuts, for example, onto the ends of the axles, thereby removably fixing the first and second variable-radius rollers 410,510 in place during operation. In addition to a butterfly nut, any other nut or fixation element may be used that may be placed at the axles to prevent slippage or removal of the first and second variable-radius rollers 410 and 510.

The first and second variable-angle mounts 413,513 may also include front and rear mount brackets. For example, the first variable-angle mount 413 may include a first front mount bracket 417 and first rear mount bracket 427. Likewise, the second variable-angle mount 513 may include a second front mount bracket 517 and second rear mount bracket 527. The front brackets 417,517 and rear brackets 427,527 may include angle fixing bolts, such as first and second angle fixing elements or bolts 418 and 518. In the exemplary variable-radius device 600, the first and second angle fixing elements 418,518 are disposed on the first and second front mount brackets 417 and 517, respectively. However, as may be understood by the person having ordinary skill in the art, such bolts may also be disposed on the first and second rear mount brackets 427 and 527. The first and second angle fixing elements 418 and 518 protrude from the front mounting brackets 417 and 517 to removably engage with first and second angle fixing channels 419 and 519, respectively.

As shown in FIGS. 8A and 8B, the variable-radius extruders 500 and 600 may include front and rear face plates 440 and 540, respectively. Such face plates 440 and 540 may include fixing channels that are configured to receive, and removably engage with first and second angle fixing channels. For example, front face plate 440 may include first and second angle fixing channels 419 and 519. Additionally, rear face plate 540 may include first and second angle fixing channels, such as fixing channel 529.

The front and rear face plates 440 and 540 may further include first and second pivot joints 405 and 505. The pivot joints 405 and 505 may include a bolt, rod, screw, or a combination thereof, that may pass through the face plates 440 and 540 and engage with the front and/or rear mounting brackets (i.e., mounting brackets 417, 517, 427, and 527). The pivot joints disposed on the face plates 440 and 540 allow the first and second variable-radius rollers 410 and 510 to rotate about the rotational axis of the pivot joints, such as pivot joints 405 and 505. As can be understood from the foregoing, a first and second variable forming angle is provided by the mounting brackets 417 and 517, through the pivot joints 405 and 505, respectively, and a plane passing through the pivot joints 405 and 505 that is parallel to the rotational axis of the passive roller 430. Indeed, the rotational axis of the passive roller 430 may be understood to pass through the shaft 432 of the passive roller 430. In certain embodiments of the invention, the first and second variable forming angles are equal in magnitude to provide a symmetrical triangular cross-section at the variable rolling die 402.

When the first and second variable forming angles are reduced in magnitude, the triangular cross-section of the rolling die 402 becomes more concave. In contrast, when the first and second variable forming angles are increased in magnitude, the triangular cross-section of the rolling die 402 becomes less concave. Therefore, a user may adjust the first and second variable forming angles by loosening or otherwise releasing the engagement between the first and second angle fixing elements 418,518 and the first and second angle fixing channels 419,519. The first and second variable forming angles may be further adjusted during operation to taper the preform material over its length rather than maintain a fixed triangular cross-section at the rolling die 402. Moreover, this ability to vary the forming angles during operation allows for formable materials to be extruded having near net shape based on the fill requirements of the void space. This shape may be determined by finding the area required with the ply boundary radius and then the corresponding location on the variable-radius roller adjusted to match the cross-sectional area by varying the first and second forming angles.

Front and rear face plates 440 and 540, respectively, may also include apertures or guides 445. Indeed, front face plate 440 may include a first aperture or guide 245 through which a filler preform may pass and thereby enter the extruders 500 and 600 in alignment with the variable rolling die 402. Although not pictured, a second aperture or production port may be provided on the rear face plate 540 in line with first aperture 445. Therefore, during operation of the exemplary extruders 500 and 600, the preform filler may pass through the first aperture 445, enter the variable rolling die 402 and, after being formed, may exit the extruders 500 and 600 at the second aperture disposed at the rear face plate 540.

Referring to FIG. 8B more specifically, an axle 433 may be provided to the shaft 432. Moreover, the axle 432 may be operably connected with a drive assembly 460. The drive assembly 460 may include a manual drive assembly, such as a hand crank, or a powered drive assembly, such as one or more electric motors, and may communicate with the drive assembly 460 to drive or otherwise rotate the passive roller 430. However, in certain other embodiments, the passive roller 430 may be allowed to roll freely. Indeed, in other aspects of the invention, the drive assembly 460 may be operably connected to the first variable-radius roller 410 and/or the second variable-radius roller 510 through an axle of the first and/or second variable-radius roller 410,510.

In other aspects of the invention, the extruders 500 and 600 may be mounted upon a mounting platform or other assembly that may support the extruder 500 or 600. For example, the mounting platform may include one or more brackets that support the passive roller 430 through the axle 433 and my further include one or more brackets for mounting the front and rear face plates 440 and 540, respectively. The axle mounting platform may have one or more bearing assemblies allowing the passive roller 430 to freely rotate about its axis of rotation.

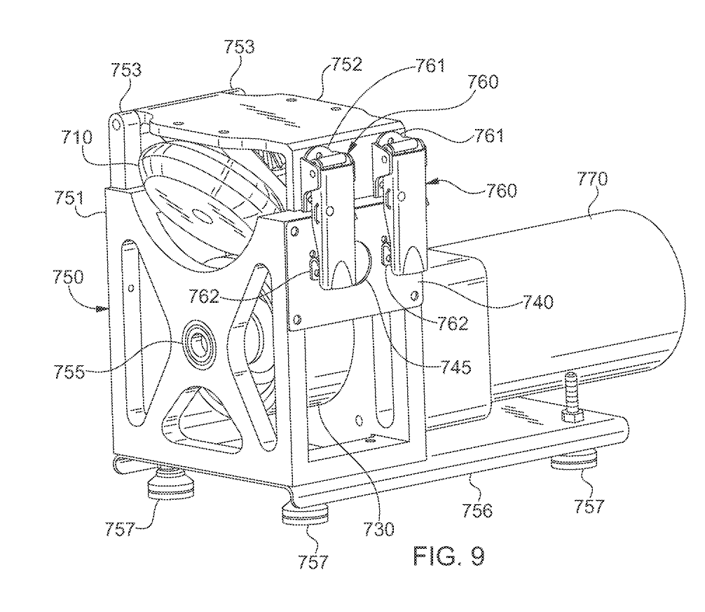

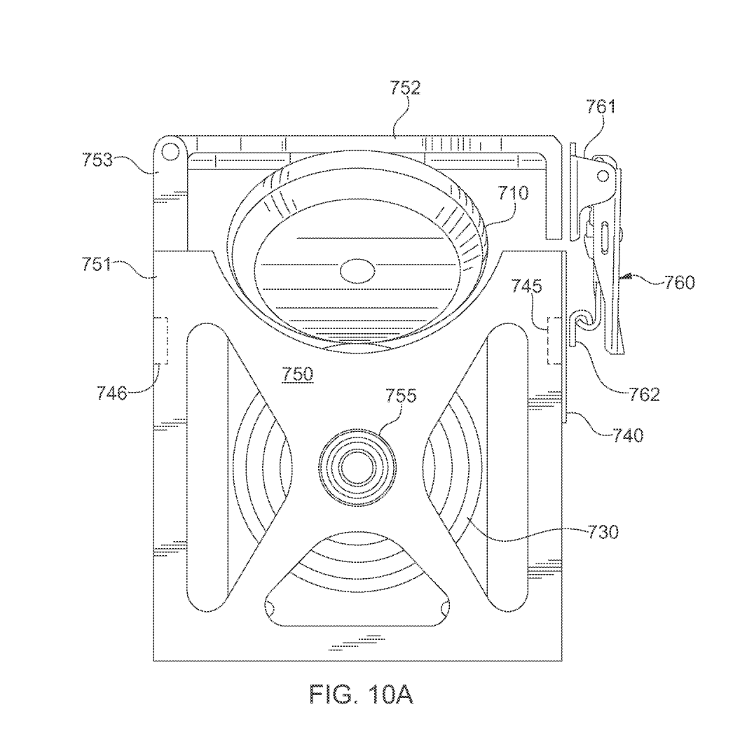

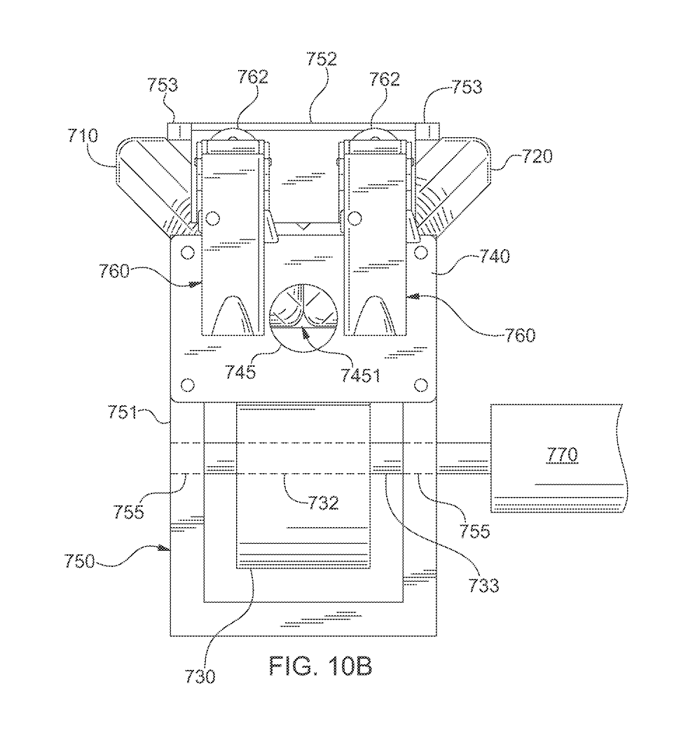

In another exemplary embodiment, the present invention includes extruder 700 that can be used to form or extrude formable materials, which is depicted in FIGS. 9-11. Referring to FIGS. 9, 10A, and 10B, the extruder 700 includes a first angled roller 710, a second angled roller 720, and a passive roller 730. In extruder 700, the first angled roller 710, second angled roller 720, and the passive roller 730 are composed of metal. Specifically, the first angled roller 710, second angled roller 720, and the passive roller 730 are composed of steel or aluminum. Regarding the extruder 700 more broadly, the passive roller 730 is driven by a powered drive assembly 770, which is an electric drive assembly or electric motor. Accordingly, the first angled roller 710 and second angled roller 720 are not independently driven by a motor. Indeed, the first angled roller 710 and second angled roller 720 may be caused to rotate due to their contact with the passive roller 730.

The extruder 700 also includes a housing 750. The housing 750 includes a first housing portion 751 and second housing portion 752. the passive roller 730 is mounted at the first housing portion 751 while the first angled roller 710 and second angled roller 720 are mounted at the second housing portion 752. The first housing portion 751 and second housing portion 752 are rotatably coupled by hinges 753. The second housing portion 752 may be rotated about hinges 753 to open the housing 750. However, the housing 750 can be locked with housing locks 760. Moreover, the housing locks 760 can be used to bias the first angled roller 710 and second angled roller 720, which are mounted on the second housing portion 752, against the passive roller 730.

The housing 750 includes a face plate 740 that is mounted at the front of the housing 750. The face plate 740 includes a first aperture or guide 745. The first aperture 745 is provided as an intake for a length of formable material. As shown specifically in FIG. 10A, the housing 750 also includes a second aperture or production port 746. The second aperture 746 is provided as an outlet for formed formable materials as they are processed through rolling die 7451, which is formed by forming surfaces of the first angled roller 710 and second angled roller 720 in conjunction with the counter surface of the passive roller 730. For example, a formable material can enter the first aperture 745 and is thereby guided into the rolling die 7451 for extrusion. The extruded form material then exits the extruder 700 via the second aperture 746.

With respect to housing locks 760, the locks include a first lock portion 761 and the second lock portion 762. The first lock portions 761 are mounted at a front surface of the second housing portion 752. The second lock portion 762 is mounted at the face plate 740. As shown in FIG. 9, the housing latches 760 are preferably spring-loaded draw latches that can bias the first lock portion 761 towards the second lock portion 762.

Addressing the passive roller 730, the roller includes an axle 733 that passes through a shaft 732. The axle 733 is rotatably mounted at axle mounts 755, which are located at opposite sides of the housing 750. As shown in FIG. 10B, the axle 733 traverses the housing 750 and is connected to the powered drive assembly 770.

The housing 750 and powered drive assembly 770 (i.e., an electric motor) are both connected to a base 756. Moreover the base 756 includes adjustable supports 757. The extruder 700 has four adjustable supports 757. The powered drive assembly 770 can include one or more of an on/off switch, a roller speed control toggle that adjusts the speed of the powered drive assembly 770 and thereby the speed of the passive roller 730, and a power cord that may be connected to a source of electrical power.

The axle mounts 755 also include bearing assemblies 7551 and 7552. The bearing assemblies 7551 and 7552 can both support the axle 733 and allow the axle 733 to rotate freely within the housing 750.

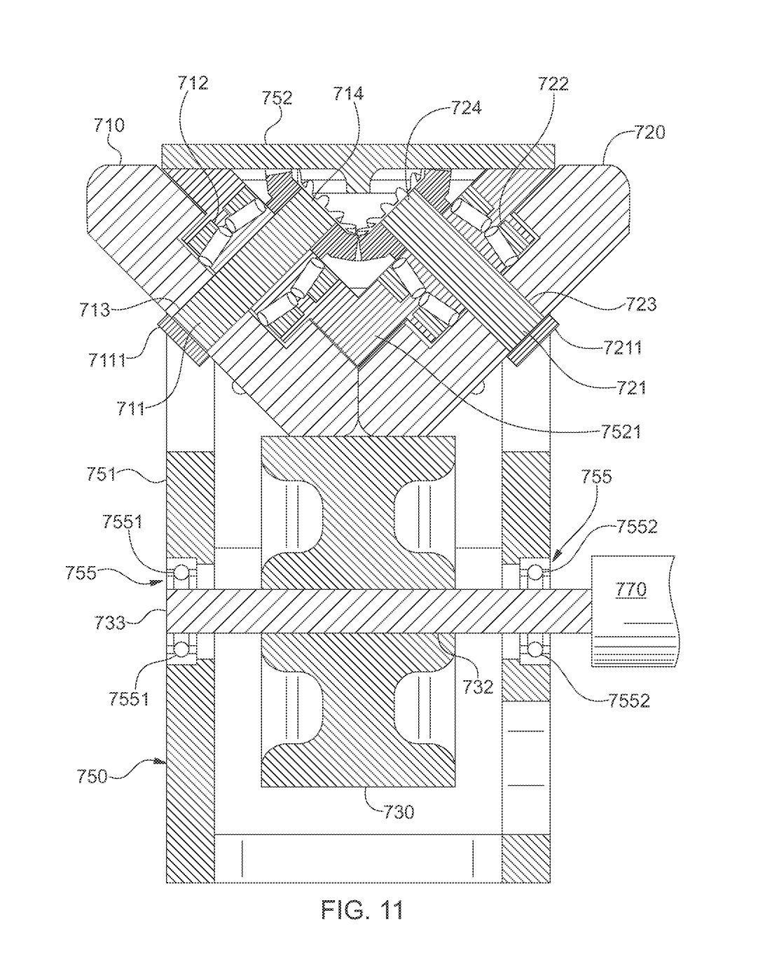

Turning to FIG. 11, the first angled roller 710 and second angled roller 720 are connected to the second housing portion 752 through a roller support 7521. Although the roller support 7521 is shown in FIG. 11 as being connected to the second housing portion 752, is understood that the roller support 7521 could be an extension of the second housing portion 752. Indeed, the roller support 7521 and second housing portion 752 could be fabricated as one monolithic structure.

The angled rollers 710 and 720 are rotatably connected to the roller support 7521 through axles 711 and 721, respectively, which pass through shafts 713,723. Specifically, angled rollers 710 and 720 are connected to axles 711 and 721, which are rotatably mounted to the roller support 7521 at roller bearing assemblies 712 and 722, respectively. In certain configurations of the extruder 700, the first angled roller 710 and the second angled roller 720 can be removably fixed to the axles 711 and 721, respectively, with the aid of fixation elements 7111 and 7211. The fixation elements 7111,7211 can be butterfly nuts that are turned on to the ends of the axles 711,721, thereby removably fixing the first and second angled rollers 710,720 in place during operation. In addition to butterfly nuts, any other nut or fixation element can be used at the axles 711,721 to prevent slippage or removal of the first and second angled rollers 710,720 during operation.

The axles 711 and 721 also include gears 714 and 724. The gears 714 and 724 intermesh within the roller support 7521. Although gears 714 and 724 are optional, the gears allow the angled rollers 710 and 720 to rotate simultaneously at the same rate.

Regarding operation of the extruder 700, the user can first disengage the housing locks 760 to open the housing 750 and expose the first angled roller 710 and second angled roller 720. As described herein, different angled rollers may be selected to provide a rolling die having a selected triangular cross-section. Upon selection of the preferred angled rollers, such angled rollers can be mounted at the roller support 7521 as first angled roller 710 and second angled roller 720. The angled roller 710 and 720 can then be removably fixed at the axles 711 and 721, respectively. Fixation elements 7111,7211 can be applied to removably fix the angled rollers 710 and 720.

After removably fixing the angled rollers 710 and 720, the second housing portion 752 can then be rotated to close the housing 750. The housing 750 can then be locked in place by engaging housing locks 760, which can include biasing elements that bias the first angled roller 710 and second angled rollers 720 against the passive roller 730 (i.e., spring loaded draw latches).

The powered drive assembly 770 can then be activated to rotate the passive roller 730. Upon rotation of the passive roller 730, the first angled roller 710 and second angled roller 720 are also rotated due to their frictional engagement with the passive roller 730. A length of formable material can then be fed into the first aperture 745 and formed by the rolling die 7451. After forming, the formed material exits the extruder 700, and particularly the housing 750, at the second aperture 746.

The configuration of extruder 700 that is set forth in FIGS. 9-11 can extrude formed filler materials with a triangular cross-section or, more particularly, a concave triangular cross-section.

The following example describes the invention in further detail. This example is provided for illustrative purposes only, and should in no way be considered as limiting the invention.

### EXAMPLE

In an exemplary use of the devices of the invention, an extruder 200 according to FIGS. 3 to 5 was fabricated and preform material was extruded through the device and compared to a preform material that was shaped using a method known in the field.

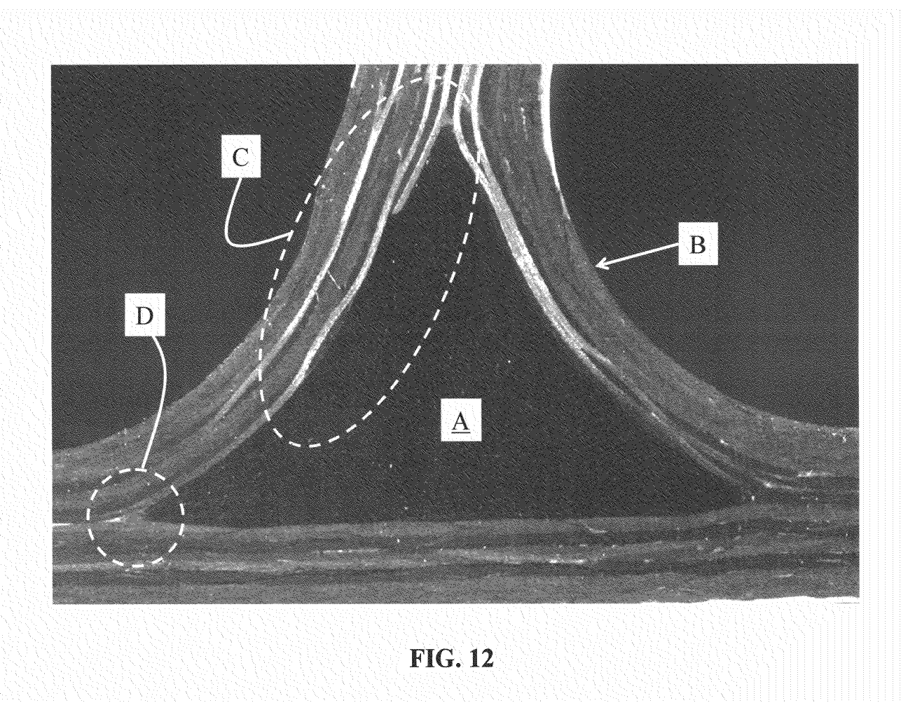

A cross-section of a void space that has been filled with a pre-form material shaped by a known method is shown in FIG. 12. Specifically, the triangular preform material (area A) was shaped using a tightly rolled noodle that was vacuum formed and placed into a spar void space (area B). As demonstrated in FIG. 12, the triangular material (area A) does not fill the entire void space. Moreover, the need for a tightly rolled noodle creates dense preforms with high internal friction. The density contributes in preventing the noodle to penetrate the void completely. In addition, low pressure and high pressure areas (area C) exist. At the low pressure areas, resin pools and fibers may distort. At the high pressure areas, density applies more pressure along the tool radius apex and bleeding plies are observed. For example, at area (area D) there are resin pools due to the existence of a low pressure area from the radius created along the edge of the dense noodle.

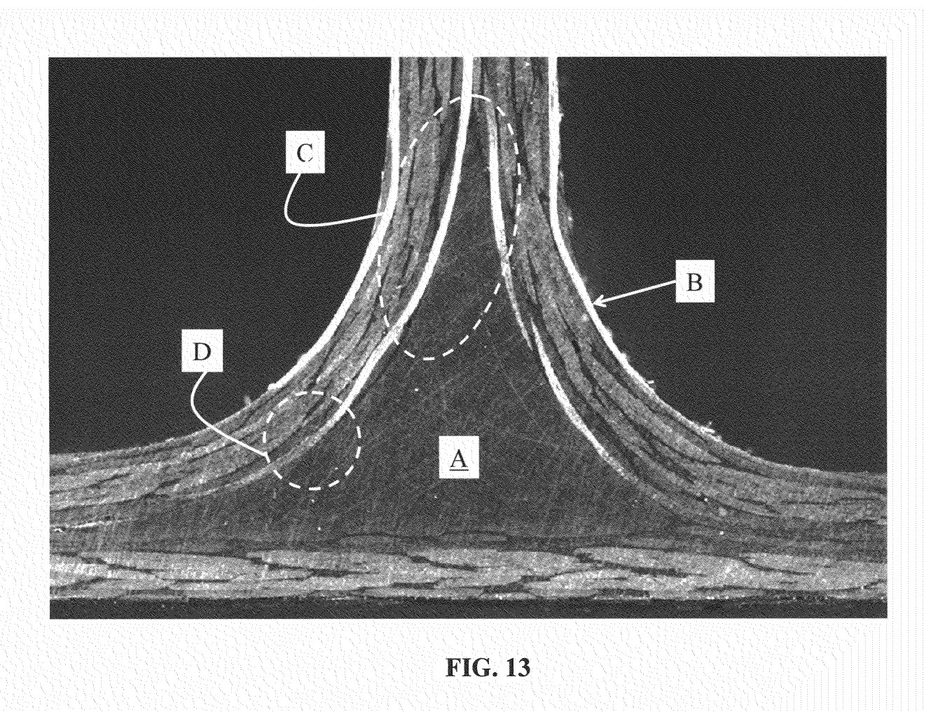

In contrast a cross-section of a void space that has been filled with a pre-form material shaped by a method and device of the invention according to FIGS. 3 to 5 is shown in FIG. 13. Specifically, the triangular preform material (area A) was shaped using a loosely rolled noodle, a triangular cross-section, and was placed into flap void space (area B). As seen in area (area C), the noodle better conforms to the shape of the void and pooling is eliminated due to the deeper penetration. Moreover, ply thickness is maintained and fiber distortion eliminated (see, for example, area (area D)).

Therefore, as demonstrated between FIGS. 12 and 13, the devices of the invention provide formed materials having triangular cross-sections that may better fit and conform to the void spaces existing in certain aircraft components and thereby improve the component's structural integrity.

A number of patent and non-patent publications may be cited herein in order to describe the state of the art to which this invention pertains. The entire disclosure of each of these publications is incorporated by reference herein.

While certain embodiments of the present invention have been described and/or exemplified above, various other embodiments will be apparent to those skilled in the art from the foregoing disclosure. The present invention is, therefore, not limited to the particular embodiments described and/or exemplified, but is capable of considerable variation and modification without departure from the scope and spirit of the appended claims.

Moreover, as used herein, the term “about” means that dimensions, sizes, formulations, parameters, shapes and other quantities and characteristics are not and need not be exact, but may be approximate and/or larger or smaller, as desired, reflecting tolerances, conversion factors, rounding off, measurement error and the like, and other factors known to those of skill in the art. In general, a dimension, size, formulation, parameter, shape or other quantity or characteristic is “about” or “approximate” whether or not expressly stated to be such. It is noted that embodiments of very different sizes, shapes and dimensions may employ the described arrangements.

Furthermore, the transitional terms “comprising”, “consisting essentially of” and “consisting of”, when used in the appended claims, in original and amended form, define the claim scope with respect to what unrecited additional claim elements or steps, if any, are excluded from the scope of the claim(s). The term “comprising” is intended to be inclusive or open-ended and does not exclude any additional, unrecited element, method, step or material. The term “consisting of” excludes any element, step or material other than those specified in the claim and, in the latter instance, impurities ordinary associated with the specified material(s). The term “consisting essentially of” limits the scope of a claim to the specified elements, steps or material(s) and those that do not materially affect the basic and novel characteristic(s) of the claimed invention. All devices and methods described herein that embody the present invention can, in alternate embodiments, be more specifically defined by any of the transitional terms “comprising,” “consisting essentially of,” and “consisting of.”

What is claimed is:

1. An extruder for forming materials comprising:
a. a first angled roller having a first forming surface;
b. a second angled roller having a second forming surface proximate the first angled roller; and
c. a passive roller having a counter surface proximate the first angled roller and the second angled roller, with the first forming surface, second forming surface, and counter surface arranged to extrude a formable material with a triangular cross-section;
wherein one or more of the first angled roller, second angled roller, and passive roller is configured to be driven by a drive assembly.

2. The extruder of claim 1, wherein at least one of the first angled roller and second angled roller is configured to be driven by a drive assembly.

3. The extruder of claim 1, wherein the passive roller is configured to be driven by a drive assembly.

4. The extruder of claim 1, comprising a drive assembly that is connected to one or more of the first angled roller, second angled roller, and passive roller.

5. The extruder of claim 4, wherein the drive assembly comprises a manual drive assembly or a powered drive assembly.

6. The extruder of claim 4, wherein the drive assembly is an electric motor that is connected to the passive roller.

7. The extruder of claim 1, wherein the triangular cross-section comprises a concave triangular cross-section or a convex triangular cross-section.

8. The extruder of claim 1, wherein at least one of the first forming surface and second forming surface is rounded having a radius.

9. The extruder of claim 8, wherein the radius is about 0.01 to 100 inches.

10. The extruder of claim 8, wherein the radius is about 0.1 to 10 inches.

11. The extruder of claim 1, wherein the counter surface is flat, convex, or concave.

12. The extruder of claim 1, wherein the first and second angled rollers comprise first and second beveled inner faces, respectively, wherein the first beveled inner face is configured to contact the second beveled inner face.

13. The extruder of claim 1, wherein the first and second angled rollers comprise first and second beveled outer faces, respectively, wherein the first and second beveled outer faces are configured to contact the passive roller.

14. The extruder of claim 1, comprising a heating element configured to heat the formable material.

15. The extruder of claim 14, wherein the heating element comprises an infrared (IR) heating element.

16. A variable-radius extruder for forming materials comprising:
a. a first roller having a first curved forming surface that comprises two or more radii;
b. a second roller having a second curved surface that comprises two or more radii, the second roller proximate the first roller; and
c. a passive roller having a counter surface proximate the first roller and the second roller, with the first curved surface, second curved surface, and counter surface arranged to extrude a formable material with a triangular cross-section;
wherein the first and second rollers are positioned with respect to the counter surface at a forming angle, wherein adjusting the forming angle varies the triangular cross-section.

17. The variable-radius extruder of claim 16, wherein one or more of the first roller, second roller, and passive roller is configured to be driven by a drive assembly.

18. The variable-radius extruder of claim 16, wherein the triangular cross-section is a concave triangular cross-section.

19. The variable-radius extruder of claim 16, wherein the two or more radii of the first and second curved forming surfaces comprise radii of about 0.01 to 100 inches.

20. The variable-radius extruder of claim 16, wherein the two or more radii of the first and second curved forming surfaces comprise radii of about 0.1 to 10 inches.

21. The variable-radius extruder of claim 16, wherein the two or more radii of the first and second curved forming surfaces comprise a first radius (R1), a second radius (R2), a third radius (R3), and a fourth radius (R4).

22. The variable-radius extruder of claim 16, wherein the first and second rollers are configured such that increasing the forming angle decreases the radius of the first and second curved forming surfaces.

23. The variable-radius extruder of claim 16, wherein the first and second rollers are configured such that decreasing the forming angle increases the radius of the first and second curved forming surfaces.

24. The variable-radius extruder of claim 16, wherein the counter surface is flat, convex, or concave.

25. The variable-radius extruder of claim 16, wherein the drive assembly comprises a manually-rotated drive assembly or a powered drive assembly.

26. The variable-radius extruder of claim 16, comprising a heating element configured to heat the formable material.

27. The variable-radius extruder of claim 26, wherein the heating element comprises an infrared (IR) heating element.

28. A method of shaping a formable material with an extruder comprising a first angled roller, a second angled roller, and a passive roller, the method comprising the steps of:
a. aligning the first angled roller, second angled roller, and passive roller to provide a rolling die having a triangular cross-section, wherein the first and second angled rollers comprise first and second forming surfaces, respectively;
b. providing a formable material to the rolling die; and
c. forming the formable material by drawing the formable material through the rolling die;
wherein forming the formable material comprises applying a first forming force to the formable material with the first angled roller, a second forming force to the formable material with the second angled roller, and a third forming force to the formable material with the passive roller.

29. The method of claim 28, wherein the step of forming the formable material comprises driving one or more of the first angled roller, second angled roller, and passive roller with a drive assembly.

30. The method of claim 29, wherein the drive assembly comprises one of a manual drive assembly and powered drive assembly.

31. The method of claim 28, wherein the step of aligning comprises positioning the first angled roller and second angled roller at a forming angle between a face of the first angled roller and the second angle roller.

32. The method of claim 31, comprising the step of varying the forming angle to adjust the triangular cross-section of the rolling die.

33. The method of claim 28, wherein the triangular cross-section comprises a convex triangular cross-section or a concave triangular cross-section.

34. The method of claim 28, wherein the triangular cross-section comprises a concave triangular cross-section.

35. The method of claim 28, comprising the step of heating the formable material.

36. The method of claim 35, wherein the step of heating the formable material comprises infrared heating.
